(19) United States
(12) Patent Application Publication
(10) Pub. No.: US 2010/0015354 A1
(43) Pub. Date: Jan. 21, 2010

(54) Method of making rollers with a fine pattern

(76) Inventor: Tai-Cheung Lee, Linkou Hsiang (TW)

Correspondence Address: COOPER & DUNHAM, LLP, 30 Rockefeller Plaza, 20th Floor, NEW YORK, NY, 10112, US

(21) Appl. No.: 12/218,544

(22) Filed: Jul. 16, 2008

(51) Int. Cl. B05D 3/06

(52) U.S. Cl. 427/555

(57) ABSTRACT

A method of making rollers with a fine pattern has the acts of casting a ceramic layer onto a roller surface, grinding and polishing the roller surface, forming a pattern on the roller surface with laser, and cleaning the roller surface. Therefore, the roller thus made has a pattern with higher precision than the conventional method of mold casting. Since the roller surface has a ceramic layer that has better resistance to erosion than steel, the roller has a longer lifetime.

### BACKGROUND OF THE INVENTION

1. Field of the Invention

The invention relates to a method of making a roller, in particular, to a method of making a roller with a fine pattern.

2. Description of Related Art

A patterned roller has applications in various technical fields. For example, such a roller can be used to make laser hologram label, transfer patterns on anti-counterfeiting labels or an anilox roller used in the manufacturing of liquid crystal displays (LCD). Normally, a roller is formed with the desired pattern and then transfers the pattern on to a target object. When making the patterned roller, a surface of a steel roller is first ground to remove unsmooth stuff thereon. The roller surface is then polished to produce a specular surface. Afterwards, a mold is used to cast the desired pattern on the roller surface. Finally, the roller surface is cleaned to ensure the quality of subsequent products.

Due to the material characteristics of the steel roller and the limitation of mold casting, the roller can only be formed with helical or quadrangular patterns. The best precision of the pattern thus made cannot satisfy the requirements of modern LCD fabrication. Moreover, the steel roller is less resistant to erosion. Therefore, the pattern is often deformed after long time uses. The roller thus has a shorter lifetime.

To overcome the shortcomings, the present invention provides a method of making a roller with a fine pattern to mitigate or obviate the aforementioned problems.

### SUMMARY OF THE INVENTION

The objective of the present invention is to increase the roller lifetime and to produce a high-precision pattern thereon. The invention provides a new manufacturing method. According to the method, the roller surface is formed with a ceramic layer to prevent the roller from damages due to erosion. Laser is then employed to form a high-precision pattern on the ceramic layer.

To achieve the above-mentioned objectives, the disclosed method of making a roller includes the steps of: blurring the steel roller surface, forming a ceramic layer on the surface of the roller; grinding the roller surface; polishing the roller surface; forming a pattern on the roller using laser; and cleaning the roller surface.

The disclosed method forms the pattern on the surface of the ceramic layer using laser. Therefore, the pattern has a better precision than the conventional method of mold casting. Moreover, since the invention has a ceramic layer first formed on the roller, it has a longer lifetime than rollers made in the conventional method because it is more resistant to erosion.

Other objectives, advantages and novel features of the invention will become more apparent from the following detailed description when taken in conjunction with the accompanying drawings.

### BRIEF DESCRIPTION OF THE DRAWINGS

FIG. 1 is a flowchart of a method of making roller with a fine pattern in accordance with the present invention;

FIG. 2 shows the step of blurring the roller surface according to the invention;

FIG. 3 shows the step of forming a ceramic layer on the roller surface according to the invention;

FIG. 4 shows the step of grinding the roller surface according to the invention;

FIG. 5 shows the step of polishing the roller surface according to the invention;

FIG. 6 shows the step of forming a pattern on the roller using laser according to the invention;

FIG. 7 is a cross-sectional and side view of the ceramic layer on the roller surface that is formed with a pattern using laser;

FIG. 8 is a top view of the patterned roller surface according to the preferred embodiment of the invention;

FIG. 9 shows the step of cleaning the roller surface according to the invention; and

FIG. 10 is a perspective view of the roller manufactured according to the invention.

### DETAILED DESCRIPTION OF THE PREFERRED EMBODIMENT

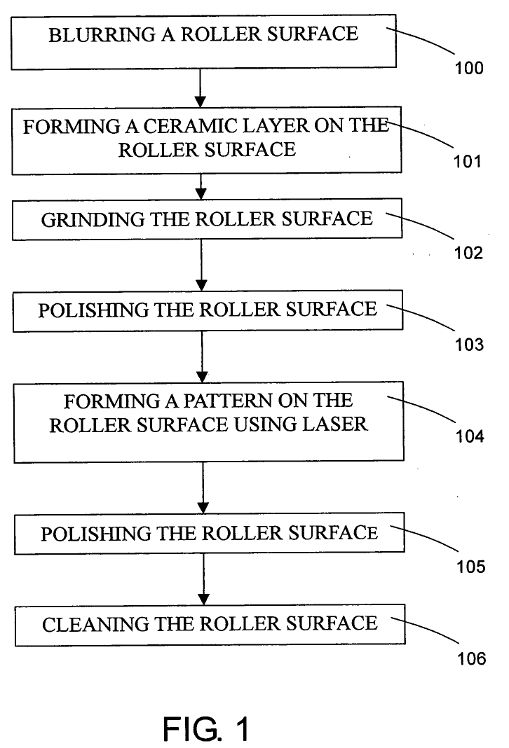

With reference to FIG. 1, a method in accordance with the present invention includes the following acts: blurring a roller surface (100), forming a ceramic layer on the roller surface (101), grinding the roller surface (102), polishing the roller surface (103), forming a pattern on the roller surface using laser (104), further polishing the roller surface (105) and cleaning the roller surface (106).

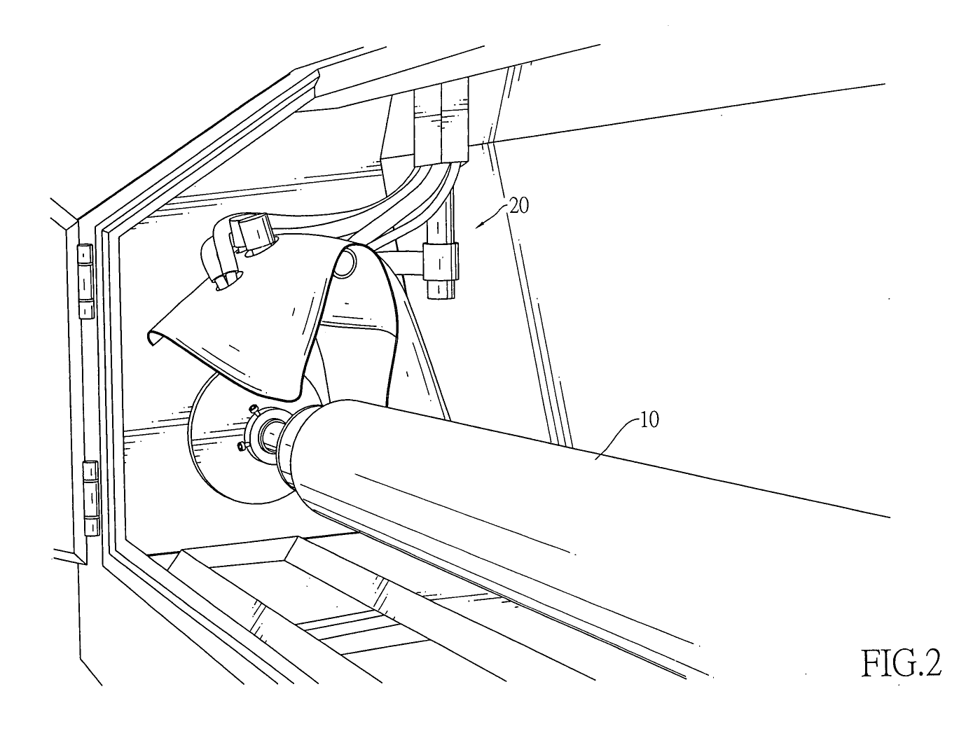

With reference to FIG. 2 for the act of blurring the roller surface (100), the roller surface is blurred so that it becomes rough and non-specular. The blurring process can be achieved using a sand blaster 20. Compressed air pushes polishing sands to hit the surface of a metal roller 10, forming a blurred surface thereon.

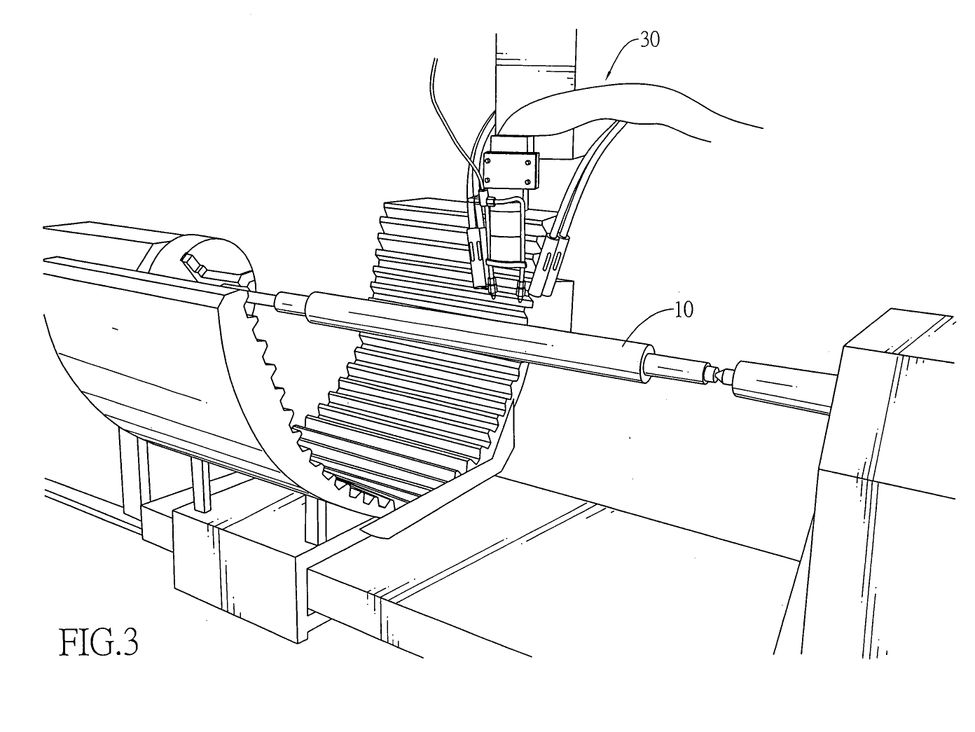

With reference to FIG. 3 for the act of forming a ceramic layer on the roller surface (101), the roller 10 is mounted on a plasma spray coating machine 30. The plasma spray coating technique is used to cast an auxiliary bond layer on the roller 10. Ceramic particles are then plasma thermal sprayed onto the auxiliary bond layer. The auxiliary bond layer consists of 70˜80% Ni and 20˜30% WC—Co, Cr₃C₂, Cr₃C₂—NiCr, and Cr. The ceramic particle consists of 95% of Cr₂O₃ because Cr₂O₃ can be readily cut by laser. The rest 5% of the ceramic particle consists of Al₂O₃, TiO₂, ZrO₂, and Y₂O₃ to enhance the erosion resistance of the ceramic layer and to increase the ease of laser cut. During the thermal spray coating process, the auxiliary bond layer is welded due to the high temperature of plasma flame. The auxiliary bond can thus be uniformly coated onto the roller 10. The welded auxiliary bond layer is cured when it is coated on the roller 10. With the blurred surface of the roller 10, the auxiliary bond layer can be tightly adhered onto the roller surface. The ceramic particles are spray coated on the auxiliary bond layer in the same way as the auxiliary bond layer. The bonding between ceramic particles and steel is not good. Therefore, the purpose of having the auxiliary bond layer is to enhance the bond force of the ceramic layer on the roller surface.

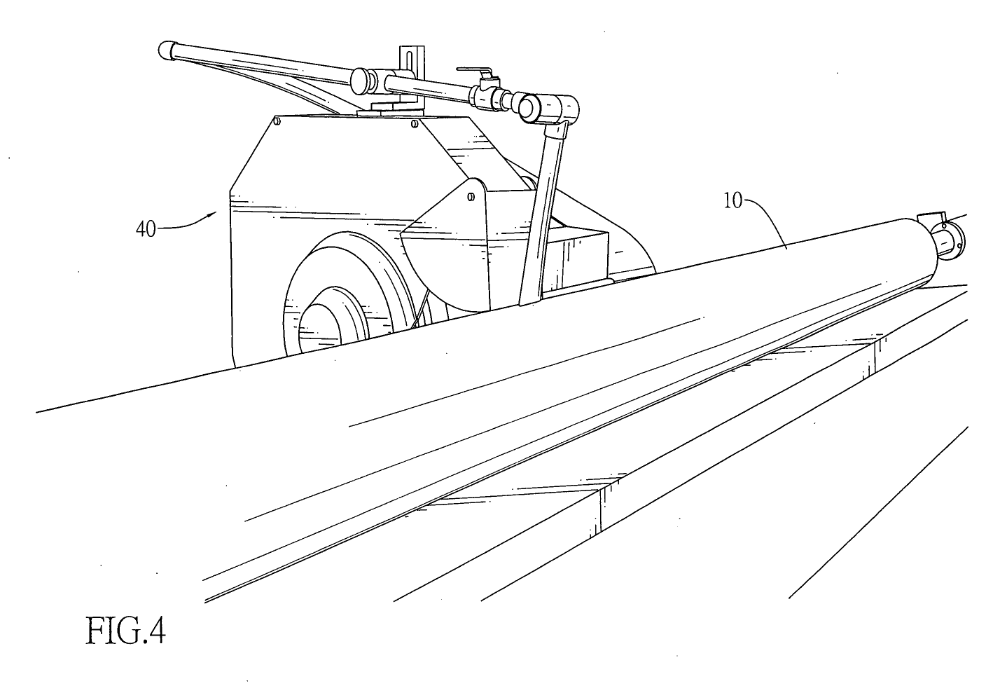

With reference to FIG. 4 for the act of grinding the roller surface (102), the roller 10 is disposed on a grinding machine 40 to smooth the surface of the roller 10 coated with the ceramic layer.

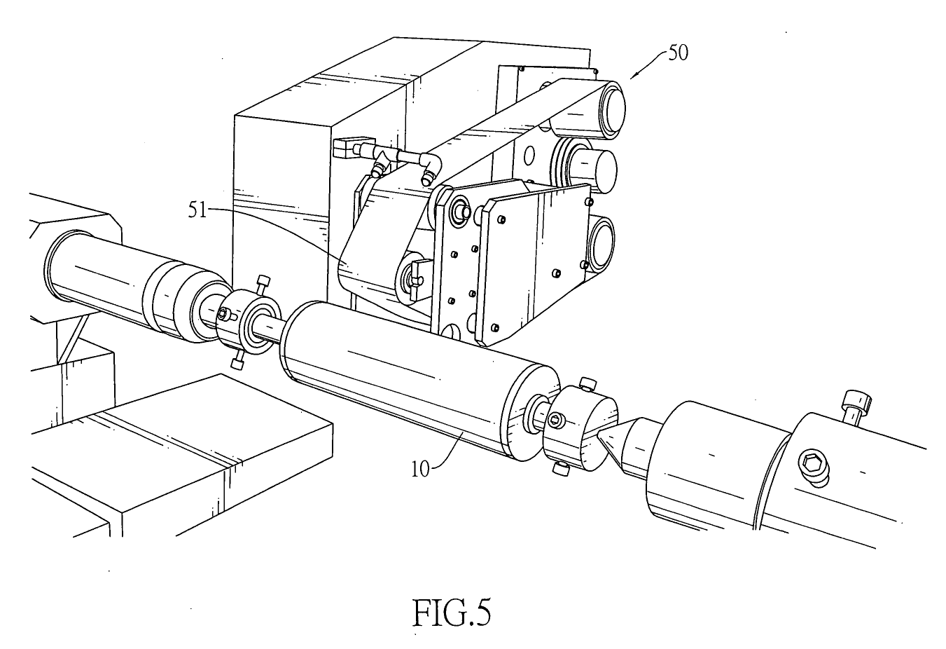

With reference to FIG. 5 for the act of polishing the roller surface (103), a polishing machine 50 is used to further polish the roller surface, producing a specular surface. In this embodiment, the polishing machine 50 uses a polishing belt 51 of diamonds. As diamonds are extremely hard, they can polish the ceramic layer into a very smooth surface. For example, the roughness of the polished roller surface can reach 0.1 micron.

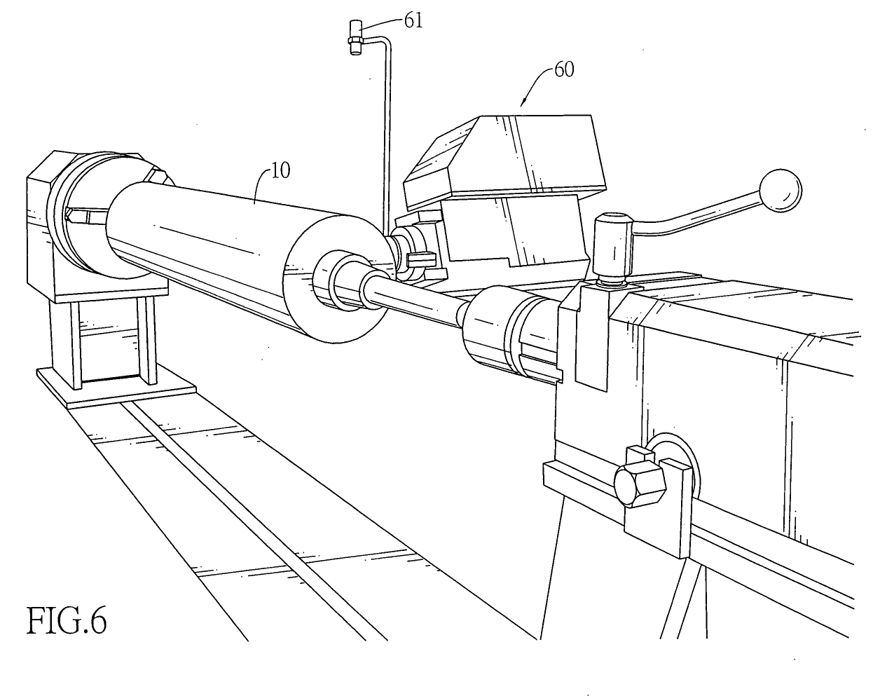

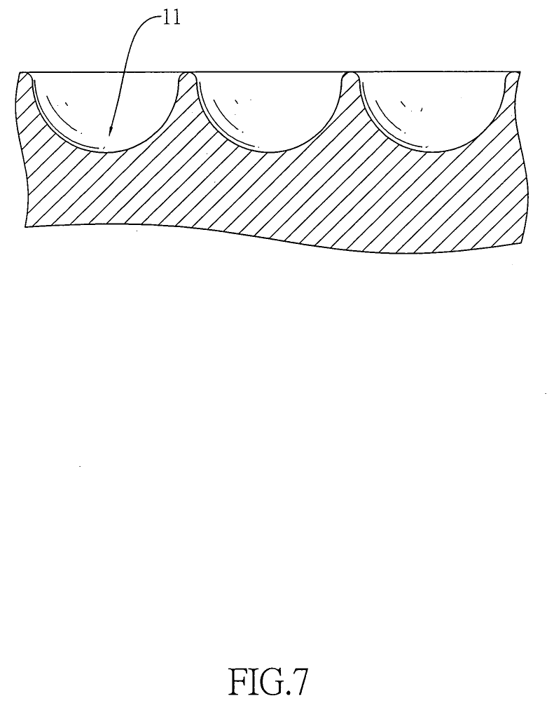

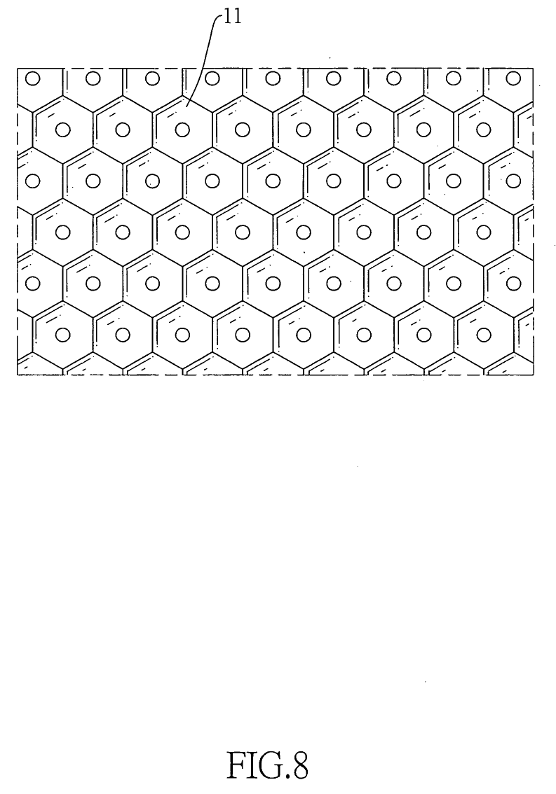

With reference to FIG. 6 for the act of forming a pattern on the roller using laser (104), a laser-sculpting machine 60 with several laser diodes is used. Laser beams produced by the laser diodes are converged. The emitted laser has a wavelength between 1060 to 10600 nanometers and a power of a few hundred watts. With further reference to FIGS. 7 and 8, when the laser beam hits one spot on the ceramic layer on the surface of the roller 10, the ceramic layer at the spot is melted by high temperature, forming a concave portion 11. The melted ceramic around the spot is pushed toward boundary of the concave portion 11 and raises, thereby forming a pattern unit.

In this embodiment, the roller 10 is an anilox roller used in the fabrication of LCD. By controlling the laser-sculpting machine 60 to move the laser head 61, the laser beam hits the roller 10 horizontally to form the concave portions 11. This also controls the lines per inch (LPI) in the pattern formed on the roller 10. Each concave portion 11 corresponds to the position between two adjacent concave portions 11 in the previous row of the pattern. Therefore, the boundaries of adjacent concave portions 11 push against each other to form a line. As a result, after the laser beam finishes the exposure, the left, right, upper left, upper right, lower left, and lower right corners of each concave portion 11 push against the adjacent concave portions 11, forming hexagons. The closely connected hexagons form a honeycomb-like pattern.

Moreover, by controlling the wavelength and power of the laser, the depth and width of the concave portion 11 can be precisely controlled as well. For example, for a roller with 300 LPI and for the concave portions to have a width of 76 to 80 microns, a depth of 18 to 30 microns, and a distance of 5 to 9 microns to adjacent concave portions, the thickness of the transferred alignment film is between 1200 and 1800 angstroms (Å). For a roller with 500 LPI and for the concave portions to have a width of 43 to 47 microns, a depth of 11 to 16 microns, and a distance of 4 to 8 microns to adjacent concave portions, the thickness of the transferred alignment film is between 500 and 900 Å. Therefore, a meshed patterns 111 of different densities, sizes, and depths can be used in the manufacturing processes of LCD's of different sizes and applications. However, the concave portions 11 are left with ceramic powders due to the deformation of the ceramic layer.

The act of further polishing the roller surface (105) is implemented in the same way as the act of polishing the roller surface (103). However, the purpose of this step is to further polish the uneven ceramic surface after the laser sculpting.

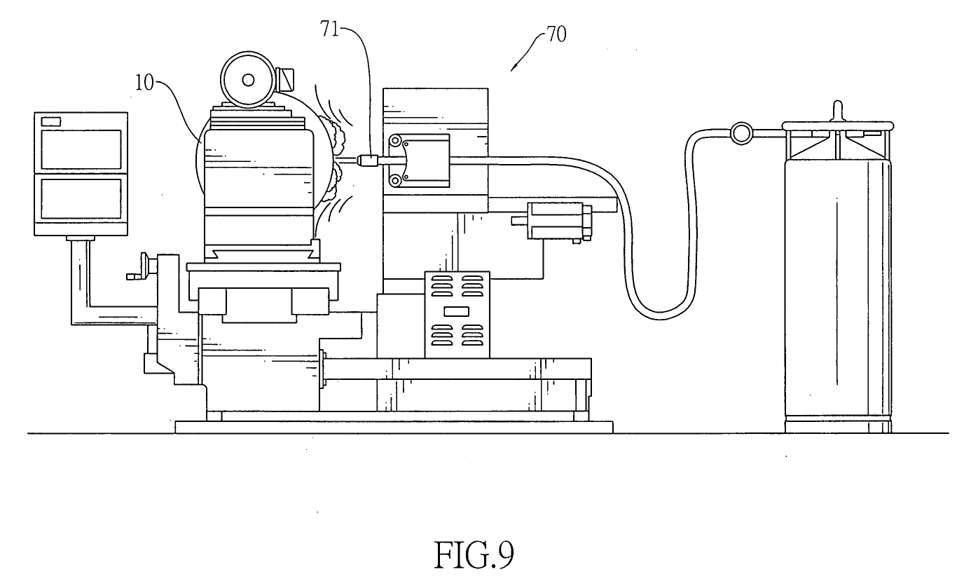

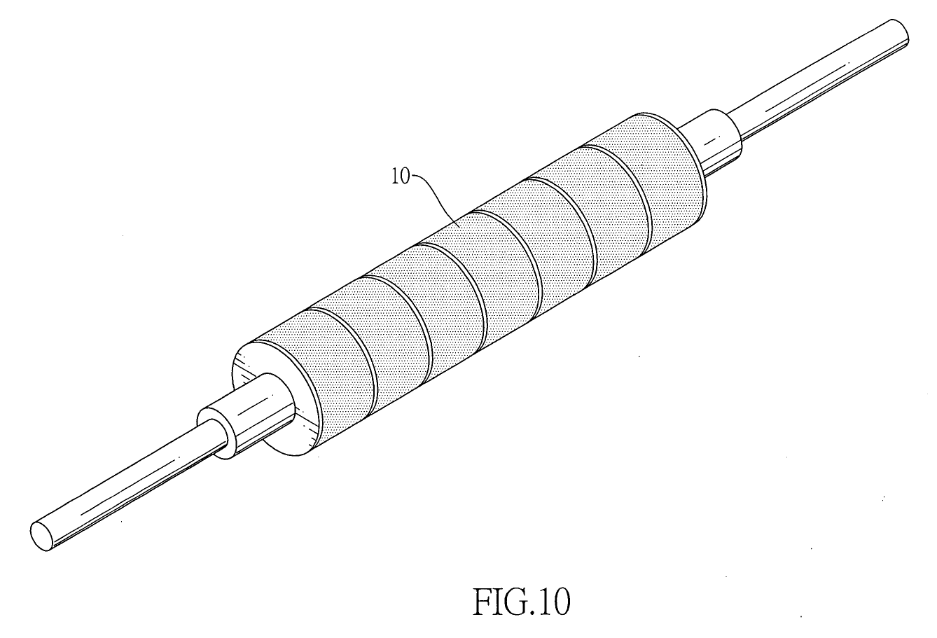

With reference to FIG. 9 for the act of cleaning the roller surface (106), a carbon dioxide cleaner 70 is used. One nozzle 71 of the carbon dioxide cleaner 70 points toward the roller surface and ejects high-pressure carbon dioxide. Since the ejected carbon dioxide is solid at that instant, it has an impact on the ceramic powders left in the concave portions 11. The ceramic powders thus leave the concave portion 11. At this moment, carbon dioxide also changes from the solid state to the gas state. Consequently, there is no remainder on the roller 10. As a result, a roller with a precision pattern is finished as shown in FIG. 10.

In summary, the roller prepared according to the disclosed method has a ceramic layer on its surface. This can enhance the erosion resistance of the roller and thus elongate its lifetime. Using a polishing belt attached with diamonds, the roller surface is polished to be very smooth to increase the printing yield. Besides, using the laser-sculpting machine that can control the wavelength and power of the laser beam, the desired pattern can be formed on the roller surface. The depth and width of the pattern can also be controlled. Finally, it is cleaned using high-pressure carbon dioxide. Since no carbon dioxide and debris is left on the roller surface, the invention achieves a good cleaning effect.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method of making a roller with a precision pattern, comprising the acts of:
forming a ceramic layer on a roller surface;
grinding the roller surface;
polishing the roller surface;
forming a pattern on the roller surface using laser; and
cleaning the roller surface.

2. The method as claimed in claim 1, wherein the method further comprising an act of blurring the roller surface before the act of forming the ceramic layer on the roller surface.

3. The method as claimed in claim 2, wherein the act of blurring the roller surface is performed by sand blasting technique.

4. The method as claimed in claim 1, wherein the act of forming the ceramic layer on the roller surface is performed by plasma spray coating technique to cast ceramic particles on the roller surface.

5. The method as claimed in claim 2, wherein the act of forming the ceramic layer on the roller surface is performed by plasma spray coating technique to cast ceramic particles on the roller surface.

6. The method as claimed in claim 3, wherein the act of forming the ceramic layer on the roller surface is performed by plasma spray coating technique to cast ceramic particles on the roller surface.

7. The method as claimed in claim 4, wherein the method further comprises an act of coating an auxiliary bond onto the roller surface before casting the ceramic layer onto the auxiliary bond layer.

8. The method as claimed in claim 7, wherein the auxiliary bond layer consists of 70% to 80% of Ni and the rest 20% to 30% is a mixture of WC—Co, Cr3C2, Cr3C2-NiCr, and Cr.

9. The method as claimed in claim 7, wherein the ceramic layer consists of 95% of Cr2O3 and 5% of a mixture of Al2O3, TiO2, ZrO2, and Y2O3.

10. The method as claimed in claim 1, wherein the act of polishing the roller surface uses a polishing belt with diamonds to smooth the roller surface.

11. The method as claimed in claim 2, wherein the act of polishing the roller surface uses a polishing belt with diamonds to smooth the roller surface.

12. The method as claimed in claim 3, wherein the act of polishing the roller surface uses a polishing belt with diamonds to smooth the roller surface.

13. The method as claimed in claim 4, wherein the act of polishing the roller surface uses a polishing belt with diamonds to smooth the roller surface.

14. The method as claimed in claim 13, wherein the act of forming a pattern on the roller surface uses a laser-sculpting machine to form the pattern on the roller surface.

15. The method as claimed in claim 14, wherein the laser-sculpting machine forms a honeycomb-like pattern on the roller surface.

16. The method as claimed in claim 1, wherein the act of cleaning the roller surface roller uses high-pressure carbon dioxide to clean the roller surface.

17. The method as claimed in claim 2, wherein the act of cleaning the roller surface roller uses high-pressure carbon dioxide to clean the roller surface.

18. The method as claimed in claim 14, wherein the act of cleaning the roller surface roller uses high-pressure carbon dioxide to clean the roller surface.

19. The method as claimed in claim 15, wherein the act of cleaning the roller surface roller uses high-pressure carbon dioxide to clean the roller surface.
